(19) United States
(12) Patent Application Publication
(10) Pub. No.: US 2006/0171299 A1
(43) Pub. Date: Aug. 3, 2006

(54) Maintaining life line packet-switched telephony services

(76) Inventors: Michael A. Skubisz, Durham, NH (US); Gordon A. Sherwin, Fremont, NH (US); Benjamin W. Bate, South Berwick, ME (US); Asima Kumar Mahapatra, Acton, MA (US); Edward F. Holmes, Durham, NH (US)

Correspondence Address: Devine, Millimet & Branch, P.A., 111 Amherst Street, Manchester, NH, 03101, US

(21) Appl. No.: 11/046,396

(22) Filed: Jan. 28, 2005

(51) Int. Cl. H04J 3/14; H04L 12/66

(52) U.S. Cl. 370/218; 370/352

(57) ABSTRACT

A customer premise device connects to one or more telephones at the customer's premises and provides the packet-switched telephony services over a communication line. In the event that the customer premise device fails to provide the packet-switched telephony services, a network device connected to the communication line can provide the packet-switched telephony services in place of the customer premise device to maintain life line packet-switched telephony services.

### TECHNICAL FIELD

The present invention relates to packet-switched telephony services and more particularly, to the maintenance of life line IP telephony services at a customer's premises.

### BACKGROUND INFORMATION

Telephony is the technology associated with the electronic transmission of voice, fax or other information between distant parties using a telephone. Telephony services can now be provided by using packet-switched connections to exchange voice, fax and other forms of information that have traditionally been carried over the dedicated circuit-switched connections of the public switched telephone network (PSTN). In particular, the internet protocol (IP) can be used to provide telephony services over the Internet or other type of IP network. Using IP telephony, telephone calls travel as packets of data. One type of IP telephony service is implemented using voice over IP (VoIP) standards to manage the delivery of voice information.

In the context of the new packet-switched telephony technologies, the traditional telephony services that transmit analog voice signals are often referred to as plain old telephone services (POTS). The ordinary copper telephone lines used to provide the POTS can also be used to transmit digital information at a high bandwidth. This is often referred to as digital subscriber line (DSL) technology. DSL services allow a customer to use these telephone lines to connect to a packet-switched network such as the Internet. Thus, the ordinary copper telephone line can carry packets of voice data to provide packet-switched telephony services using DSL in addition to carrying analog voice signals to provide POTS.

In some existing IP telephony systems, a customer premise device provides the conversion between the analog voice signals and the digital voice data at the customer's premises. Such devices can be used at various types of customer premises including residential premises, a home office, or a small, medium or enterprise office environment. A customer premise of any type can be vulnerable to possible loss of power or other types of failures, resulting in a loss of connectivity and IP telephony services. One solution is to provide uninterruptible power services (UPS) to maintain connectivity during errant power conditions. However, internet service providers (ISPs), Incumbent Local Exchange Carriers (ILEC), Multi Service Operators (MSO) and others are seeking other cost effective methods to offer guaranteed life line support for packet-switched telephony services.

Accordingly, there is a need for the ability to provide life line packet-switched telephony services, for example, in a residential VoIP environment, without requiring emergency power for the customer premise device.

### SUMMARY

In accordance with one aspect of the present invention, a method is provided for maintaining life line packet-switched telephony service in the event of failure of a customer premise device by using a network device to provide the packet-switched telephony service. Voice data packets are transmitted and received to and from the customer premise device during normal operation using the network device. The voice data packets from the customer premise device are monitored to detect a failure of the packet-switched telephony service provided by the customer premise device. In response to a failure, analog voice signals are transmitted and received to and from the customer premise device using the network device. The network device converts between analog voice signals and the voice data packets to provide the packet-switched telephony service during life line operation.

In accordance with another aspect of the present invention, a customer premise packet-switched telephony device comprises a communication line connection and a communication processor connected to the communication line connection for receiving and transmitting inbound and outbound voice data packets. A voice data converter connected to the communication processor converts outbound analog voice signals to outbound voice data packets and converts inbound voice data packets to inbound analog voice signals. At least one telephone interface connects to a telephone to transmit and receive the analog voice signals. A life line switch circuit selectively connects the telephone interface to the voice data converter. The life line switch circuit connects the telephone interface to the voice data converter in a normal state such that voice data packets are transmitted and received via the communication line connection. The life line switch circuit bypasses the voice data converter and the communication processor in a life line state such that analog voice signals are transmitted and received via the communication line connection.

In accordance with a further aspect of the present invention, a network device is provides life line packet-switched telephony service. The network device comprises a communication line connection and a communication processor for receiving and transmitting voice data packets. A voice data converter converts between analog voice signals and voice data packets. A splitter is connected between the communication line connection and the voice data converter and the communication processor. In a normal state, the voice data packets are passed between the communication line connection and the communication processor. In a life line state, the splitter passes analog signals between the communication line connection and the voice data converter.

### BRIEF DESCRIPTION OF THE DRAWINGS

These and other features and advantages of the present invention will be better understood by reading the following detailed description, taken together with the drawings wherein:

FIG. 1 is a functional block diagram a system for providing life line packet-switched telephony services, according to the present invention.

FIG. 2 is a flow chart illustrating the method of providing life line packet-switched telephony services, according to one embodiment of the present invention.

FIG. 3 is a schematic diagram of a broadband configuration in a normal operational state, according to one embodiment of the present invention.

FIG. 4 is a schematic diagram of the broadband configuration shown in FIG. 2 in a life line operational state.

FIG. 5 is a schematic diagram of a broadband configuration in a mixed operational state, according to a further embodiment of the present invention.

FIG. 6 is a schematic diagram of a digital loop carrier (DLC) replacement configuration, according to another embodiment of the present invention.

FIG. 7 is a schematic diagram of a broadband configuration, according to yet another embodiment of the present invention.

FIG. 8 is a flow chart illustrating one method for providing a VoIP connection on a customer premise device.

FIG. 9 is a flow chart illustrating one method for providing a VoIP connection on a network device.

### DETAILED DESCRIPTION OF THE PREFERRED EMBODIMENTS

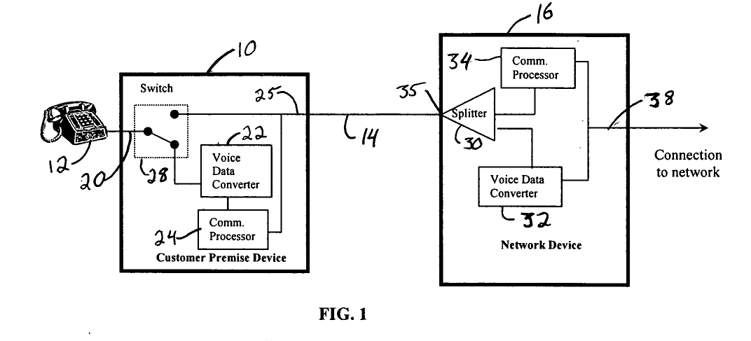

Referring to FIG. 1, a system and method for providing life line packet-switched telephony services is described in greater detail. A customer premise device 10 connects to one or more telephones 12 at the customer's premises and provides the packet-switched telephony services over a communication line 14. In the event that the customer premise device 10 fails to provide the packet-switched telephony services (e.g., as a result of a power failure), a network device 16 connected to the communication line 14 can provide the packet-switched telephony services in place of the customer premise device 10 to maintain life line packet-switched telephony services. The packet-switched telephony services provided by the customer premise device 10 can preferably be restored without interrupting any telephone calls in process.

In the exemplary embodiment, the communication line 14 is an ordinary telephone line (also referred to as the local loop) capable of carrying both analog voice signals (i.e., POTS) and voice data packets (i.e., packet-switched telephony services). In the exemplary embodiment, the packet-switched telephony services are provided using digital subscriber line (DSL) technology and using the internet protocol (IP) and specifically voice over IP (VoIP). However, other types of communication lines capable of carrying both analog voice signals and voice data packets are contemplated (e.g., cable, wireless, fiber optic) and other packet-switched protocols and techniques are contemplated (e.g., asynchronous transfer mode or ATM).

The customer premise device 10 includes a telephone interface 20 such as a POTS interface that allows analog voice signals to be received and transmitted by the telephone(s) 12. The customer premise device 10 includes a voice data converter 22 to convert between the analog voice signals and voice data packets. The voice data converter 22 can be implemented using VoIP technology known to those skilled in the art, such as a digital signal processor, codecs, and a VoIP signaling client. The customer premise device 10 also includes a communication processor 24 that transmits and receives the voice data packets via a communication line connection 26 to the communication line 14. The communication processor 24 can be implemented using DSL technology known to those skilled in the art, such as an integrated xDSL modem.

The customer premise device 10 also includes a life line switch circuit 28 that connects the telephone interface 20 to the voice data converter 22 during normal operation, i.e., when the customer premise device 10 is capable of providing the packet-switched telephony services. The life line switch circuit 28 can “shunt” the telephone interface 20 (and the customer side telephone line) directly onto the communication line 14, thereby bypassing the voice data converter 20 and the communications processor 24. The life line switch 28 thus provides a failsafe mechanism causing the analog voice signals to be transmitted and received (i.e., using POTS) over the communication line 14 during the life line operation, i.e., in the event of power loss or an equipment failure at the customer's premises.

The network device 16 also includes a communication processor 34 for transmitting and receiving the voice data packets and a voice data converter 32 for converting between analog voice signals and voice data packets. The exemplary network device 16 is a network DSL termination device. The communication processor 34 can be implemented using DSL technology known to those skilled in the art, such as an xDSL modem and/or a digital subscriber loop access manager (DSLAM). The voice data converter 32 can be implemented using existing VoIP technology such as a digital signal processor, codecs, and a VoIP signaling client.

The network device 16 also includes a splitter 30 connected to the communication line 14 via a communication line connection 35. The splitter 30 passes the voice data packets and/or the analog voice signals from the communication line 14 to the communication processor 34 and/or the voice data converter 32. During normal operation, the communication processor 34 processes the voice data packets and transfers the voice data packets via a network connection 38 to enable the telephone calls. When the communication processor 34 (e.g., the DSLAM) detects that the customer premise device 10 has switched from packet-switched telephony services to analog voice signals, the voice data converter 32 receives the analog voice signals and provides the packet-switched telephony services in place of the customer premise device 10.

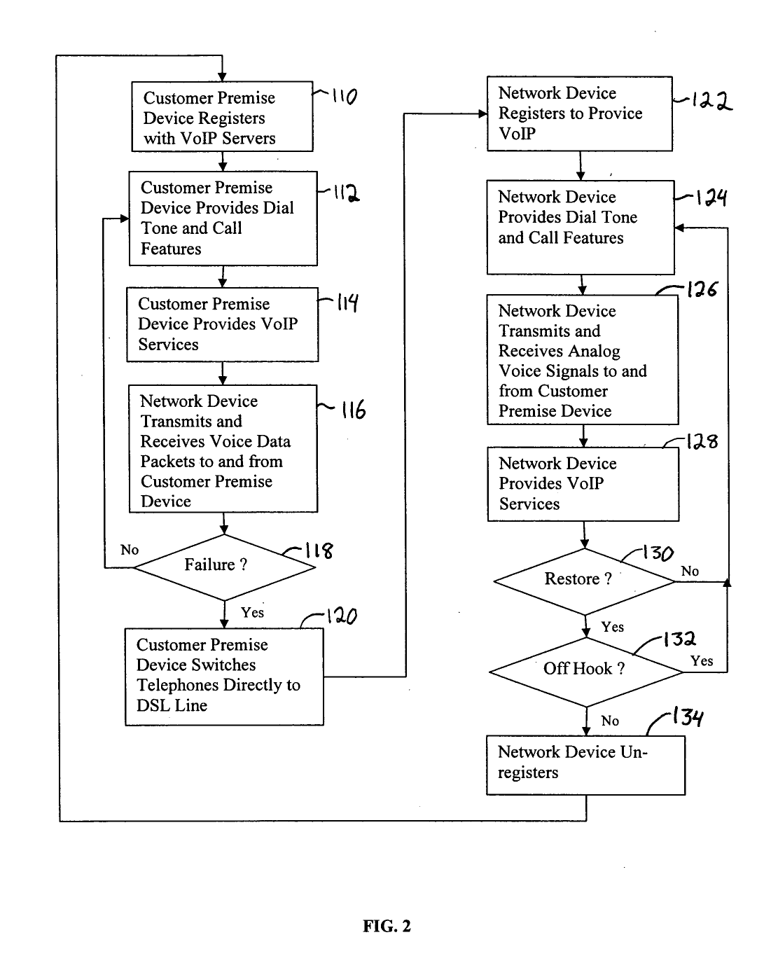

One method of providing the life line packet-switched telephony services is illustrated in FIG. 2. Initially, a VoIP client embedded in the customer premise device 10 registers itself with the VoIP servers on the network as the client responsible for providing the dial tone and call features, step 110. During normal operation, the VoIP client in the customer premise device 10 provides the dial tone and call features to the telephone(s) connected to the customer premise device 10, step 112. Because the networking device does not need to be concerned with delivery voice at this time, the VoIP client on the networking device remains idle. When a telephone call is made or received, the customer premise device 10 provides the VoIP services, step 114. For example, the VoIP client on the customer premise device 10 converts between the analog voice signals and the voice data packets (i.e., IP packets) and the xDSL modem integrated in the customer premise device 10 forwards and receives the voice data packets over the communication line 14. The network device 16 transmits and receives the voice data packets to and from the customer premise device 10 during this normal operation, step 116.

In the event of a hardware failure or a loss of power on the customer premise device 10, step 118, the customer premise device 10 bypasses the VoIP client and the xDSL modem and switches the telephones 12 directly to the communication line, step 120. The network device 16 monitors the packet-switched telephony services provided by the customer premise device 10, and when the failure is detected by the network device 16, the network device 16 registers all services associated with the VoIP client in the customer premise device 10 to the VoIP client in the network device 16. Thus, failover is essentially transparent to the customer with respect to the basic telephone service and call features. During this life line operation, the network device 16 provides the dial tone to the telephone(s) 12 connected to the customer premise device 10, step 124. When a telephone call is made or received, the network device 16 transmits and receives the analog voice signals to and from the customer premise device 10, step 126, and the network device provides the VoIP services, step 128. For example, the VoIP client on the network device 16 converts between the analog voice signals and the voice data packets (i.e., IP packets) and the xDSL modem integrated in the network device 16 forwards and receives the voice data packets over the network.

When the power is restored or other failure is corrected at the customer premise device 10, the restoration process begins, step 130. If there is a call already in process or the telephone is off hook when the premise device 10 is recovered, step 132, the premise device 10 and the network device maintain the life line services. When the telephone is placed on hook, the network device 16 un-registers its telephony services associated with the restored customer premise device 10, step 134. The customer premise device 10 can then re-register for telephony services, step 110, and proceeds with normal operation.

The telephone calls are preferably established using the Session Initiation Protocol (SIP), which allows a telephone number to exist off of different hosts (i.e., the customer premise device 10 and the network device 16). The hosts can dynamically register a telephone number with an SIP server by sending a SIP REGISTER request. The SIP server combines the results of the registrations to yield a list of locations (e.g., host addresses) capable of providing VoIP service. When a telephone call is made using VoIP, a SIP proxy server can be directed to use a particular location or to traverse through the addresses until the call is successful. In other words, the SIP proxy server will direct SIP INVITES to the network device 16 when the customer premise device 10 does not respond.

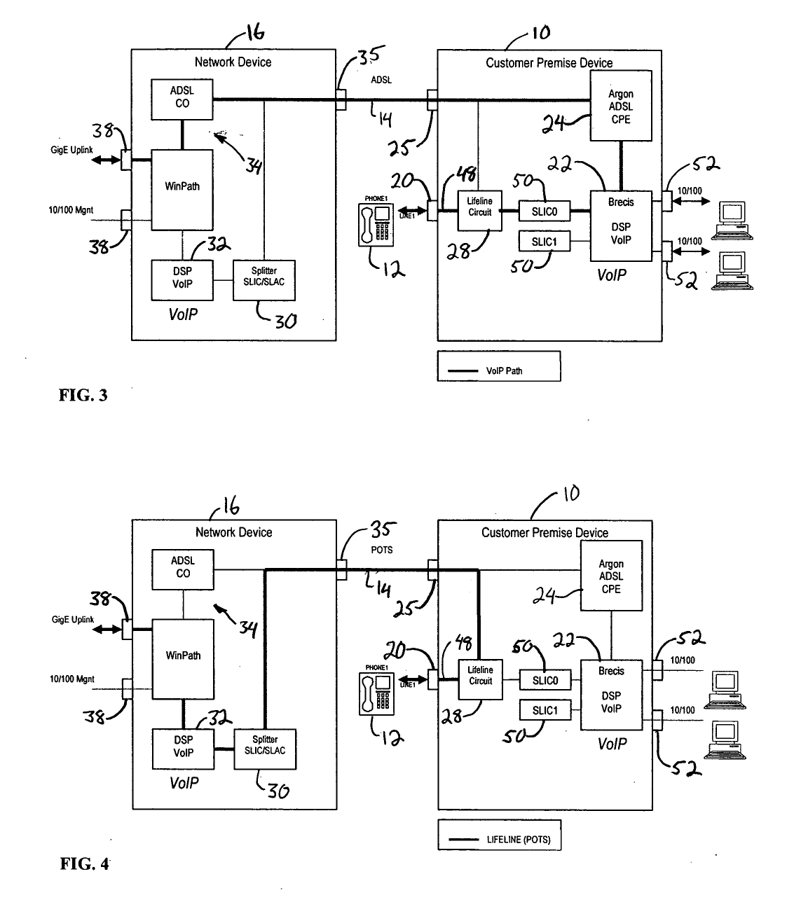

FIGS. 3-7 show various configurations and operational states of an exemplary embodiment, where like or similar parts are indicated with the same reference characters. Different configurations are possible depending upon the role that the network device 16 plays in providing VoIP services. FIGS. 3-5 show a broadband configuration where the network device 16 provides the VoIP services only if the customer premise device 10 is unable to do so. When the premise device 10 is powered off, the POTS connection (i.e., from telephone 12) is passed through the premise device 10 onto the local loop (i.e., line 14) and up to the network device 16, which provides the VoIP connection. The line that can be switched into the life line operational state is referred to as the default line 48. The network device 16 preferably provisions the default line with the same telephone number used by the premise device 10.

In the exemplary embodiment of the customer premise device 10 used in the broadband configuration, the voice data converter 22 is implemented using a DSP/VoIP client, such as the type available from BRECIS Communications Corporation, and the communication processor 24 is implemented using ADSL customer premise equipment (CPE) such as the type available under the name Argon from Globespan Virata. This embodiment of the customer premise device 10 also includes one or more subscriber line interface cards (SLIC0 and SLIC1) 50 connected between the life line switch circuit 28 and the DSP/VoIP voice data converter 22. This embodiment of the customer premise device 10 also includes one or more connections 52 to a network or personal computer.

In the exemplary embodiment of the network device 16 used in the broadband configuration, the voice data converter 32 is implemented using a DSP/VoIP client and the communication processor 34 is implemented using ADSL central office (CO) equipment and a packet processor such as the type available under the name WinPath from Wintegra. The exemplary splitter 30 incorporates electrical line protection and a low pass filter which pass low frequency analog voice signals to a subscriber line interface card (SLIC) and a subscriber line audio-processing circuit (SLAC).

The broadband configuration has three operational states, normal, life line and mixed. The normal operational state (FIG. 3) occurs when the customer premise device 10 is powered ON and detects an ADSL SHOWTIME state. In the normal operational state, VoIP is active on the customer premise device 10 and inactive on the network device 16. Thus, the customer premise device 10 waits for the ADSL SHOWTIME state before enabling VoIP connections for the POTS line(s) and sending out the SIP REGISTER request.

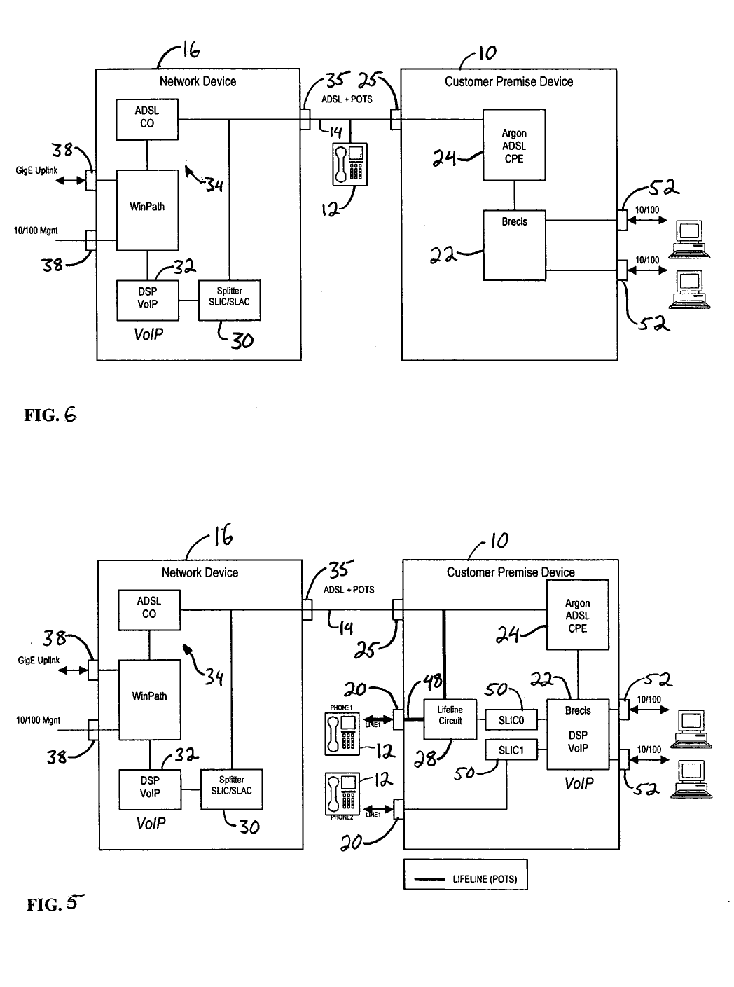

The life line operational state (FIG. 4) occurs when the customer premise device 10 is powered OFF and ADSL is in the IDLE state at the network device 16 or when the customer premise device 10 is powered ON and not in the ADSL SHOWTIME state (e.g., ADSL IDLE or ADSL TRAINING). This may be caused by a failure in the VoIP circuitry, a failure in the ADSL circuitry, or the use of a DLC replacement configuration (as shown in FIG. 6 and described below). In the life line operational state, VoIP is inactive on the premise device 10 and VoIP is active on the network device 16. In particular, when the customer premise device 10 is powered OFF or detects that the line is not in the ADSL SHOWTIME state, the life line circuit 28 is enabled on the default line 48, allowing POTS to pass through the local loop 14. When the network device 16 detects an ADSL IDLE state on the line 14, the network device 16 will provide VoIP to the line 14. In the event of a failure of the VoIP function on the customer premise device 10 (e.g., a failure in any subsystem along the path from the POTS interface to the ADSL interface), action is taken on the customer premise device 10 to force the ADSL state machine into the IDLE state.

The mixed operational state (FIG. 5) occurs when the customer premise device 10 is powered ON during the life line state and ADSL is in the SHOWTIME state. In this mixed operational state, VoIP is inactive on the customer premise device 10 for the default line and VoIP is active on the network device 16. In particular, the customer premise device 10 maintains the life line circuit when the default line 48 goes OFF-HOOK during booting or training. If the ADSL line links up while the default line 48 is still OFF-HOOK, the customer premise device 10 keeps the life line circuit active. If ADSL line links up while the local loop goes OFF-HOOK during booting or training, the network device 16 continues providing VoIP for the telephone on the local loop. If the customer premise device 10 attempts to use the default line during this state, the call will be rejected by the SIP proxy server.

FIG. 6 shows a digital loop carrier (DLC) replacement configuration where the network device 16 always provides the VoIP services. The exemplary embodiment of the customer premise device 10 used in the DLC replacement configuration does not include the telephone interface (i.e., POTS ports) and the telephone 12 is connected directly to the line 14. In this configuration, the network device 16 always provides the VoIP services and there is only a life line operational state.

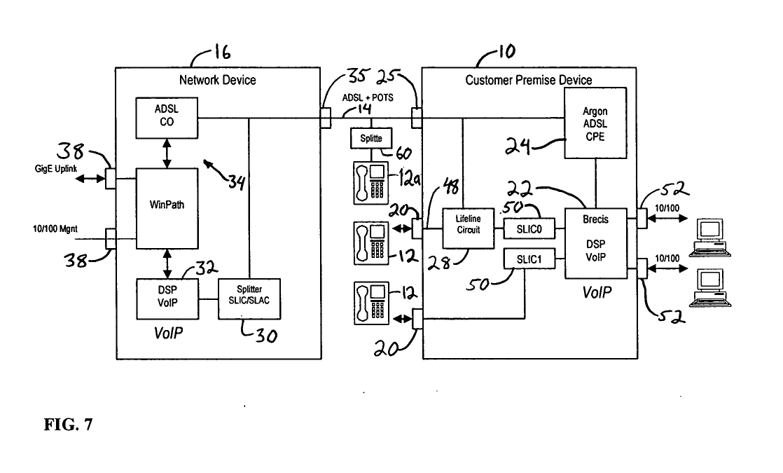

FIG. 7 shows a non-provisioned broadband configuration where a telephones 12 are connected to the customer premise device 10 and a telephone 12a is connected directly to the line 14 through a splitter 60. In this configuration, the network device 16 can always provide VoIP services to the telephone 12a, while the premise device 10 provides VoIP services to the telephones 12

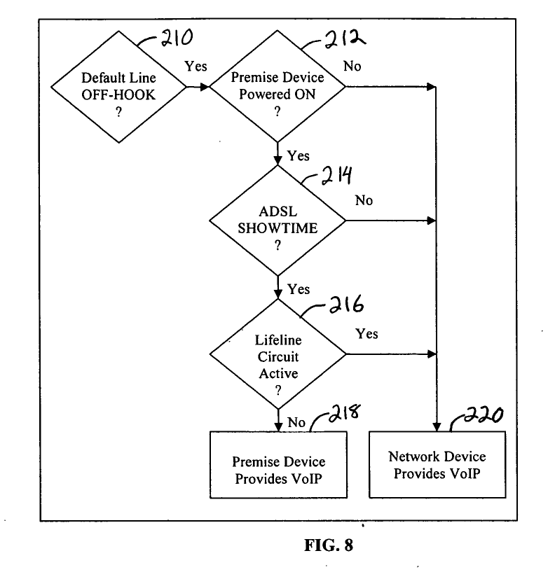

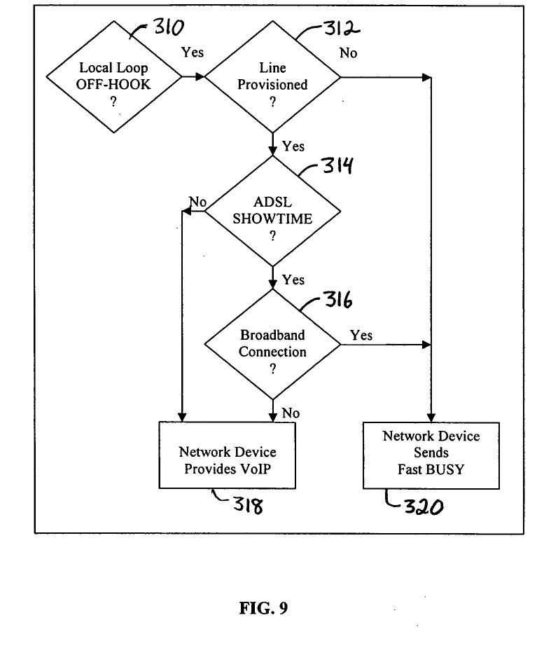

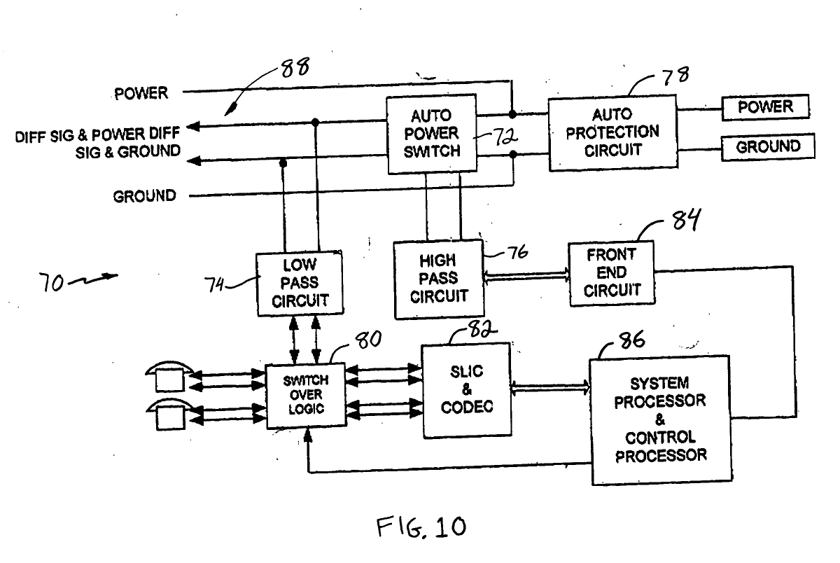

FIG. 8 illustrates the state flow for providing a VoIP connection on the premise device 10. If an OFF-HOOK state is detected by the customer premise device 10 on the default line, step 210, the customer premise device 10 determines if it should provide VoIP based on the whether or not the premise device 10 is powered ON, step 212, ADSL is in the SHOWTIME state, step 214, and the life line switch circuit is active, step 216. The premise device 10 provides VoIP to the default line, step 218, when the life line circuit is not active and ADSL is in the SHOWTIME state. Otherwise, the network device 16 provides VoIP, step 220.

FIG. 9 illustrates the state flow for providing a VoIP connection on the network device 16. If an OFF-HOOK state is detected by the network device 16 on the local loop, step 310, the network device 16 determines if it should provide VoIP based on whether or not a line is provisioned, step 312, ADSL is in the SHOWTIME state, step 314, and a broadband connection exists, step 316. In a broadband configuration, the network device 16 provides VoIP to the local loop, step 318, when the line is provisioned and ADSL is not in the SHOWTIME state. Otherwise, the network device responds with a fast BUSY signal. In the DLC replacement configuration, the network device 16 provides VoIP to the local loop if the line is provisioned.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The invention claimed is:

1. A method for maintaining life line packet-switched telephony service in the event of failure of a customer premise device by using a network device to provide the packet-switched telephony service, said method comprising the steps of:
transmitting and receiving voice data packets to and from said customer premise device during normal operation using said network device;
monitoring said voice data packets from said customer premise device to detect a failure of said packet-switched telephony service provided by said customer premise device;
responsive to said failure, transmitting and receiving analog voice signals to and from said customer premise device using said network device; and
converting between analog voice signals and said voice data packets at said network device to provide said packet-switched telephony service using said network device during a life line operation.

2. The method of claim 1 further comprising the step of: responsive to said failure, providing a dial tone from said network device to a telephone connected to said customer premise device.

3. The method of claim 1 wherein said voice data packets and said analog voice signals are transmitted and received over a digital subscriber line connecting said customer premise device to said network device.

4. The method of claim 3 wherein said voice data packets are transmitted and received using internet protocol (IP) telephony.

5. The method of claim 4 wherein said failure is detected when power fails in said customer premise device.

6. The method of claim 4 wherein said voice data packets are transmitted and received using voice over IP (VoIP).

7. The method of claim 1 further comprising the step of registering packet-switched telephony services associated with said customer premise device to the network device during said life line operation.

8. The method of claim 1 further comprising the step of restoring said packet-switched telephony services provided by said customer premise device.

9. The method of claim 8 wherein said packet-switched telephony services are restored only when a telephone connected to said customer premise device is on hook.

10. A customer premise packet-switched telephony device comprising:
a communication line connection;
a communication processor connected to said communication line connection for receiving and transmitting inbound and outbound voice data packets;
a voice data converter connected to said communication processor for converting outbound analog voice signals to outbound voice data packets and for converting inbound voice data packets to inbound analog voice signals;
at least one telephone interface for connecting to a telephone to transmit and receive said analog voice signals; and
a life line switch circuit selectively connecting said telephone interface to said voice data converter, wherein said life line switch circuit connects said telephone interface to said voice data converter in a normal state such that voice data packets are transmitted and received via said communication line connection, and wherein said life line switch circuit bypasses said voice data converter and said communication processor in a life line state such that analog voice signals are transmitted and received via said communication line connection.

11. The customer premise packet-switched telephony device of claim 10 wherein said communication line connection is a digital subscriber line (DSL) connection, and wherein said communication processor includes an xDSL modem.

12. The customer premise packet-switched telephony device of claim 11 wherein said voice data converter includes a digital signal processor and uses voice over IP (VoIP).

13. The customer premise packet-switched telephony device of claim 11 further including a subscriber line interface card connected between said life line switch circuit and said voice data converter.

14. The customer premise packet-switched telephony device of claim 10 wherein said at least one telephone interface includes first and second telephone interfaces, wherein said first telephone interface is connected to said life line switch circuit and wherein said second telephone interface is connected directly to said voice data converter.

15. The customer premise packet-switched telephony device of claim 10 wherein said life line switch circuit detects a failure and switches to said life line state in response to said failure.

16. A network device for providing life line packet-switched telephony service, said network device comprising:
a communication line connection;
a communication processor for receiving and transmitting voice data packets;
a voice data converter for converting between analog voice signals and voice data packets; and
a splitter connected between said communication line connection and said voice data converter and said communication processor, wherein voice data packets are passed between said communication line connection and said communication processor in a normal state, and wherein said splitter passes analog signals between said communication line connection and said voice data converter in a life line state.

17. The network device of claim 20 wherein said communication line connection is a digital subscriber line (DSL) connection, and wherein said communication processor includes an xDSL modem.

18. The network device of claim 20 wherein said voice data converter includes a digital signal processor and uses voice over IP (VoIP).

19. The network device of claim 20 wherein said communication processor includes a digital subscriber loop access manager (DSLAM).

20. A system for maintaining life line packet-switched telephony service, said system comprising:
a customer premise packet-switched telephony device comprising:
a communication line connection;
a communication processor connected to said communication line connection for receiving and transmitting inbound and outbound voice data packets;
a voice data converter connected to said communication processor for converting outbound analog voice signals to outbound voice data packets and for converting inbound voice data packets to inbound analog voice signals;
at least one telephone interface for connecting to a telephone; and
a life line switch circuit connecting said telephone interface to said voice data converter, wherein said life line switch circuit connects said telephone interface to said voice data converter in a normal state such that voice data packets are transmitted and received via said communication line connection, and wherein said life line switch circuit bypasses said voice data converter and said communication processor in a life line state such that analog voice signals are transmitted and received via said communication line connection; and
a network device connected to said customer premise packet-switched telephony device, said network device comprising:
a communication line connection;
a communication processor for receiving and transmitting voice data packets;
an voice data converter for converting between analog voice signals and voice data packets and;
a splitter connected between said communication line connection and said voice data converter and said communication processor, wherein voice data packets are passed between said communication line connection and said communication processor in said normal state, and wherein said splitter passes analog signals between said communication line connection and said voice data converter in said life line state.
